(19) United States
(12) Patent Application Publication
(10) Pub. No.: US 2006/0014127 A1
(43) Pub. Date: Jan. 19, 2006

(54) Instructive clock with removable numerating strips

(76) Inventor: Fu-Chi Lin, Taipei Hsien (TW)

Correspondence Address: Fu-Chi Lin, 7F., No. 213, Civic Boulevard. Sec. 4, Taipei, 105, TW

(21) Appl. No.: 10/893,635

(22) Filed: Jul. 19, 2004

(51) Int. Cl. G09B 19/12

(52) U.S. Cl. 434/304

(57) ABSTRACT

An instructive clock with removable numerating strips mainly includes a clock having time scales provided on a face thereof to show a time point indicated by hour, minute, and second hands of the clock; and at least one numerating strip in the form of an elongated strip for annularly fitting on the clock. The at least one numerating strip is provided on a front side with time marks corresponding to the time scales provided on the clock, and at two ends with corresponding female and male connectors that could be fitly engaged with each other.

### FIELD OF THE INVENTION

The present invention relates to an instructive clock with removable numerating strips, and more particularly to a numerating strip that is designed to embody the abstract time concept for children to learn about time and numbers by way of counting time marks on the numerating strip, which can be removably fitted on an instructive clock.

### BACKGROUND OF THE INVENTION

To teach children about time and using phrases about time, a teacher would usually begin with the structure of a clock, for example, hour and minute hands, and numerals on the face of the clock. In a conventional way of teaching a child about time, a toy clock is given to the child, so that the child may move the hour and minute hands to have an idea about changes of time. The child has to watch the clock face and remember that each scale represents one minute, the numeral “1” represents five minutes and “2” represents ten minutes, etc. Children do not have fun in learning time in this way because it is difficult for children to understand what it exactly means by the numerals on the clock face. For example, the children might remember that when the hour hand points to the numeral “2” and the minute hand to “12”, it means the time is two o'clock. However, they might be confused why it reads as fifteen minutes when the minute hand moves to point to the numeral “3”.

Another conventional way of teaching children about time is using an instructive clock, such as that disclosed in Taiwanese Patent Publication No. 390490. The instructive clock is designed in an attempt to convert abstract numeric concepts into concrete objects. For example, the instructive clock may have a post removably inserted at each position representing one minute. The children may remove and count the posts to learn about time. These sixty removable posts are easily lost and scattered, and are not grouped. To tell the time of one minute to two o'clock, the children have to count from the first to the fifty-ninth post. And, it will be a great challenge to the children's patient in counting so many posts. The above-mentioned instructive clock is therefore not practical for use.

It is therefore tried by the inventor to develop a device that not only eliminates the limitations in conventional ways of teaching children about time and time-related phrases, but also effectively helps children to learn and thereby understand time and numbers.

### SUMMARY OF THE INVENTION

A primary object of the present invention is to provide an instructive clock with removable numerating strips. The clock may be of any size and configuration, and the numerating strips are provided with embodied time marks and removably fitted on a face of the clock. Children are taught about concepts of time and numbers and calculation thereof through counting the time marks on the numerating strips.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a plurality of numerating strips according to a first embodiment of the present invention before being serially connected to form a ring for removably mounting on an instructive clock;

FIG. 2 is a perspective view of a ring assembled from the numerating strips of FIG. 1;

FIG. 3 is a fragmentary sectional view taken along line A-A of FIG. 2;

FIG. 4 shows a plurality of numerating strips according to a second embodiment of the present invention before being serially connected to form a ring for removably mounting on an instructive clock;

FIG. 5 is a perspective view of a ring assembled from the numerating strips of FIG. 4;

FIG. 6 shows a plurality of numerating strips according to a third embodiment of the present invention before being serially connected to form a ring for removably mounting on an instructive clock;

FIG. 7 is a perspective view of a ring assembled from the numerating strips of FIG. 6;

FIG. 8 shows a plurality of numerating strips according to a fourth embodiment of the present invention before being serially connected to form a ring for removably mounting on an instructive clock;

FIG. 9 is a perspective view of a ring assembled from the numerating strips of FIG. 8;

FIG. 10 shows a plurality of numerating strips according to a fifth embodiment of the present invention before being serially connected to form a ring for removably mounting on an instructive clock;

FIG. 11 is a perspective view of a ring assembled from the numerating strips of FIG. 10;

FIG. 12 shows a plurality of numerating strips according to a sixth embodiment of the present invention before being serially connected to form a ring for removably mounting on an instructive clock;

FIG. 13 is a perspective view of a ring assembled from the numerating strips of FIG. 12;

FIG. 14 shows an instructive clock before an assembled ring of numerating strip is fitted therearound;

FIG. 15 shows the instructive clock of FIG. 14 with the assembled ring of numerating strip fitted therearound;

FIG. 16 is a sectioned side view of FIG. 15;

FIG. 17 shows an instructive clock before an assembled ring of numerating strip is circumferentially fitted therein;

FIG. 18 shows the instructive clock of FIG. 17 with the assembled ring of numerating strip circumferentially fitted therein;

FIG. 19 is a sectioned side view of FIG. 18;

FIG. 20 shows a plurality of numerating strips according to a seventh embodiment of the present invention before being serially connected to form a ring for removably mounting on an instructive clock;

FIG. 21 is a perspective view of a ring assembled from the numerating strips of FIG. 20;

FIG. 22 is a fragmentary sectional view taken along line B-B of FIG. 21;

FIG. 23 is an instructive clock with an assembled ring of numerating strip of FIG. 21 fitted therearound;

FIG. 24 is a sectioned side view of FIG. 23;

FIG. 25 is an instructive clock with an assembled ring of numerating strip of FIG. 21 circumferentially fitted therein;

FIG. 26 is a sectioned side view of FIG. 25; and

FIG. 27 shows an example of teaching children about the concept of time using numerating strips of the present invention.

### DETAILED DESCRIPTION OF THE PREFERRED EMBODIMENTS

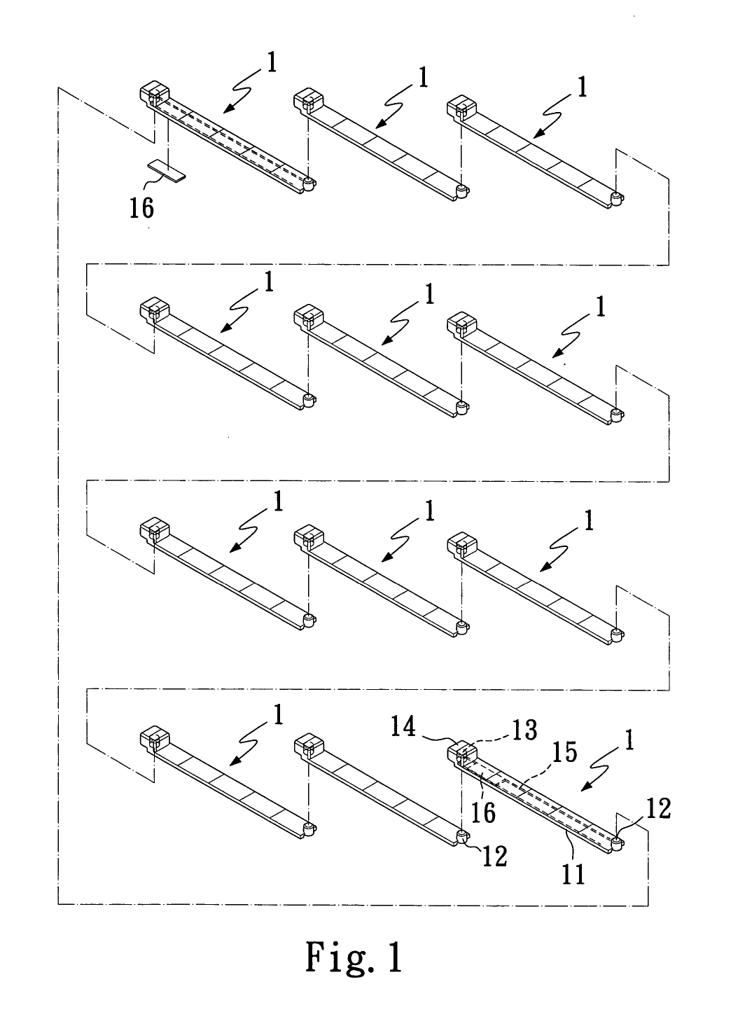

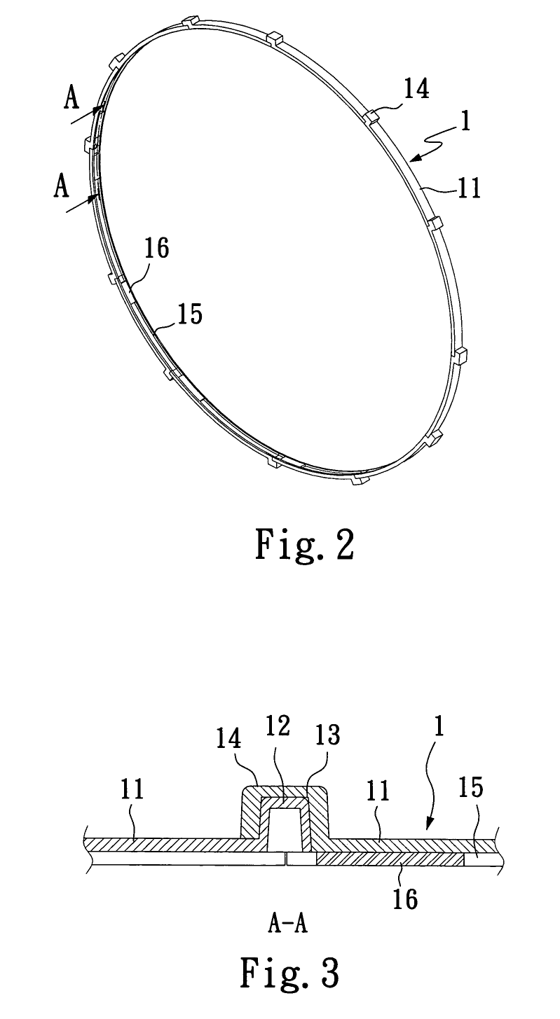

Please refer to FIGS. 1 and 2 that are respectively perspective views of a plurality of numerating strips 1 according to a first embodiment of the present invention before and after being assembled into a ring for removably fitting on an instructive clock of the present invention, and to FIG. 3 that is a fragmentary sectional views taken along line A-A of FIG. 2. As shown, the numerating strip 1 mainly includes a main body 11 having five equally spaced time marks provided on a front side thereof. Each of the time marks represents one minute, so that each numerating strip 1 represents five minutes. Twelve numerating strips 1 have total sixty time marks to correspond to the sixty minutes on a face of the instructive clock. Each main body 11 is provided at a first end with a male connector, such as a butt 12, and at a second end with a female connector, such as a cavity 13 adapted to fitly engage with the butt 12. An upward marking projection 14 is provided on the main body 11 immediately above the cavity 13. A recess 15 is formed at a back side of the main body 11 for soft magnets 16 to attach thereto, so that the numerating strip 1 could be attached to any magnetically attractive surface to facilitate teaching with the numerating strip 1. Twelve numerating strips 1 could be sequentially assembled by way of engaging the butt 12 on a preceding numerating strip 1 with the cavity 13 on a following numerating strip 1, as shown in FIG. 3, to finally form a ring of numerating strip, as shown in FIG. 2.

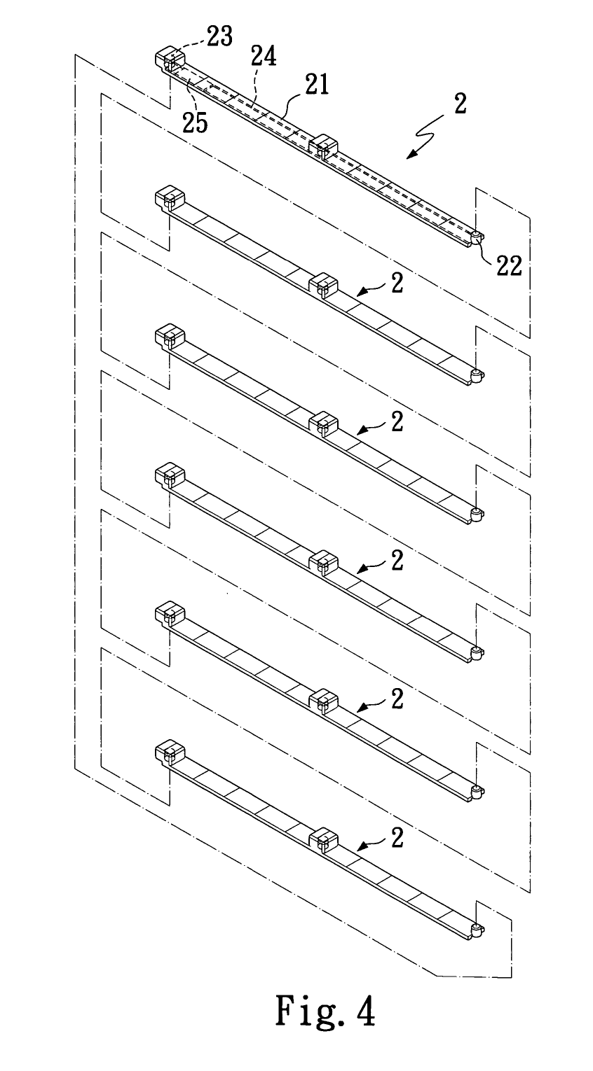

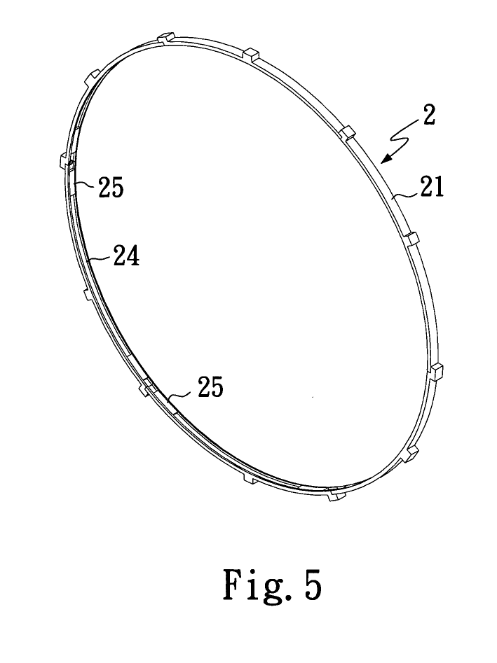

FIGS. 4 and 5 respectively shows a plurality of numerating strips 2 according to a second embodiment of the present invention before and after being assembled into a ring. The numerating strip 2 includes a main body 21 having ten equally spaced time marks provided on a front side thereof, and each of the time marks represents one minute, so that each numerating strip 2 represents ten minutes. Six numerating strips 2 have total sixty time marks to correspond to the sixty minutes on a face of the instructive clock. Each main body 21 is provided at a first end with a male connector, such as a butt 22, and at a second end with a female connector, such as a cavity 23 adapted to fitly engage with the butt 22. A recess 24 is formed at a back side of the main body 21 for soft magnets 25 to attach thereto, so that the numerating strip 2 could be attached to any magnetically attractive surface to facilitate teaching with the numerating strip 2. Six numerating strips 2 could be sequentially assembled by way of engaging the butt 22 on a preceding numerating strip 2 with the cavity 23 on a following numerating strip 2 to finally form a ring of numerating strip, as shown in FIG. 5.

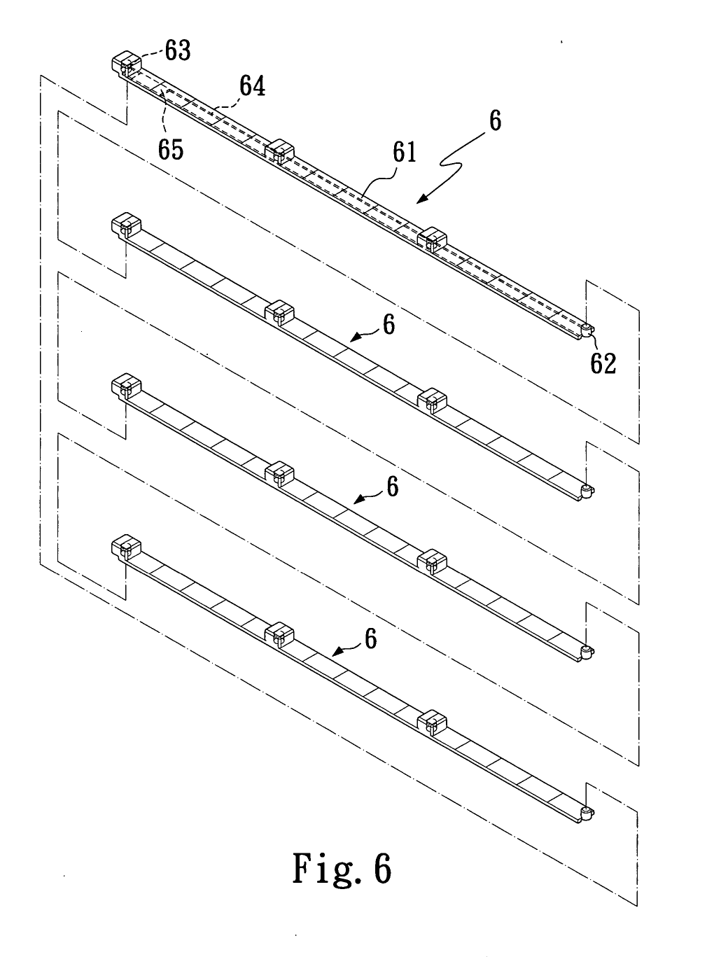

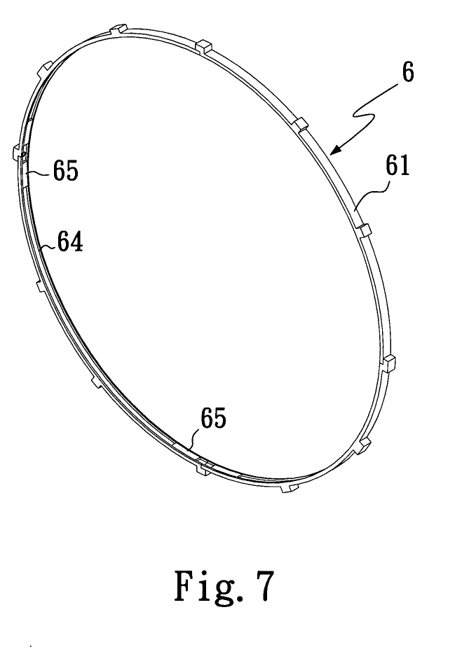

FIGS. 6 and 7 respectively shows a plurality of numerating strips 6 according to a third embodiment of the present invention before and after being assembled into a ring. The numerating strip 6 includes a main body 61 having fifteen equally spaced time marks provided on a front side thereof, and each of the time marks represents one minute, so that each numerating strip 6 represents fifteen minutes. Four numerating strips 6 have total sixty time marks to correspond to the sixty minutes on a face of the instructive clock. Each main body 61 is provided at a first end with a male connector, such as a butt 62, and at a second end with a female connector, such as a cavity 63 adapted to fitly engage with the butt 62. A recess 64 is formed at a back side of the main body 61 for soft magnets 65 to attach thereto, so that the numerating strip 6 could be attached to any magnetically attractive surface to facilitate teaching with the numerating strip 6. Four numerating strips 6 could be sequentially assembled by way of engaging the butt 62 on a preceding numerating strip 6 with the cavity 63 on a following numerating strip 6 to finally form a ring of numerating strip, as shown in FIG. 7.

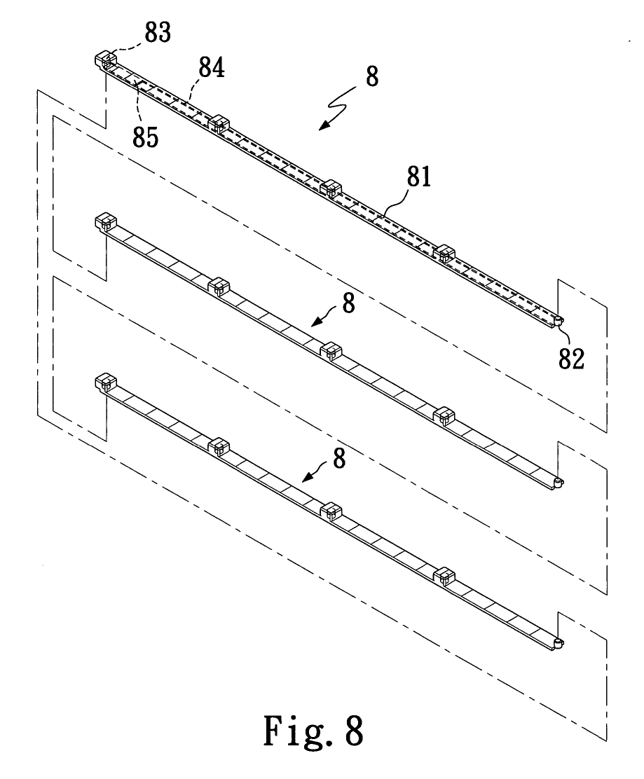

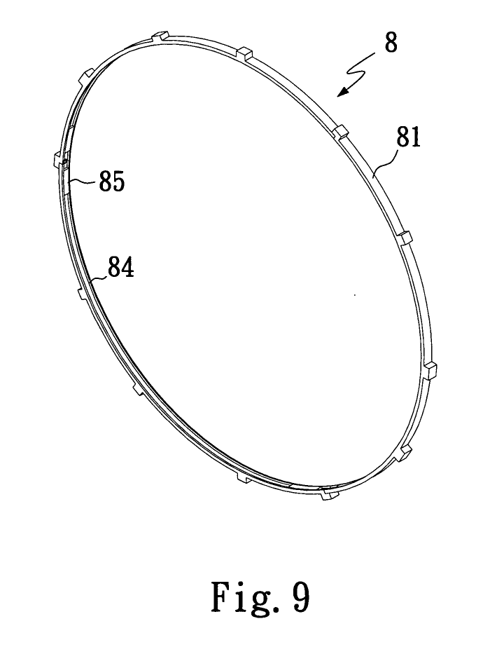

FIGS. 8 and 9 respectively shows a plurality of numerating strips 8 according to a fourth embodiment of the present invention before and after being assembled into a ring. The numerating strip 8 includes a main body 81 having twenty equally spaced time marks provided on a front side thereof, and each of the time marks represents one minute, so that each numerating strip 8 represents twenty minutes. Three numerating strips 8 have total sixty time marks to correspond to the sixty minutes on a face of the instructive clock. Each main body 81 is provided at a first end with a male connector, such as a butt 82, and at a second end with a female connector, such as a cavity 83 adapted to fitly engage with the butt 82. A recess 84 is formed at a back side of the main body 81 for soft magnets 85 to attach thereto, so that the numerating strip 8 could be attached to any magnetically attractive surface to facilitate teaching with the numerating strip 8. Three numerating strips 8 could be sequentially assembled by way of engaging the butt 82 on a preceding numerating strip 8 with the cavity 83 o a following numerating strip 8 to finally form a ring of numerating strip, as shown in FIG. 9.

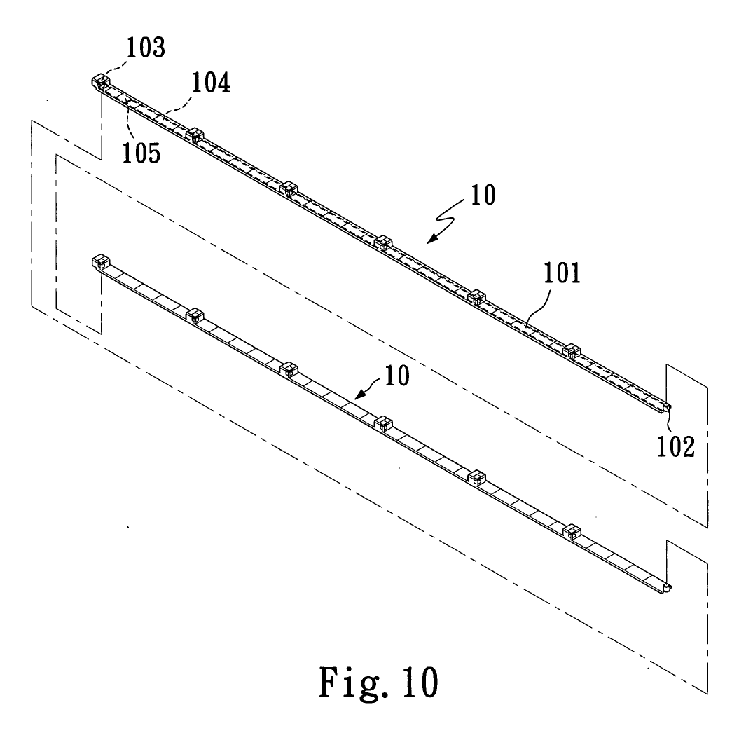

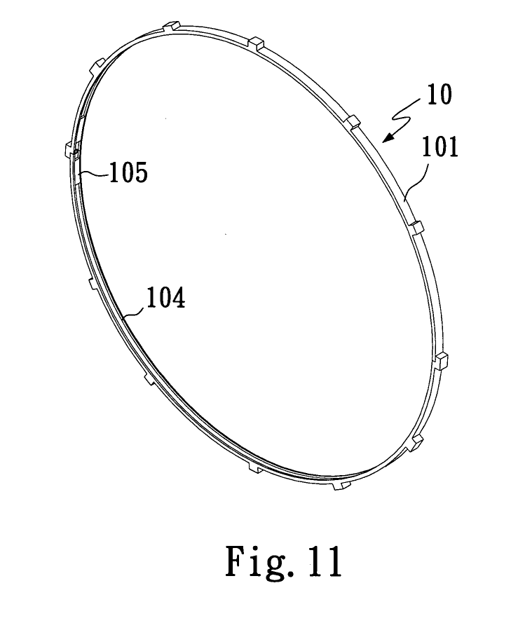

FIGS. 10 and 11 respectively shows a plurality of numerating strips 10 according to a fifth embodiment of the present invention before and after being assembled into a ring. The numerating strip 10 includes a main body 101 having thirty equally spaced time marks provided on a front side thereof, and each of the time marks represents one minute, so that each numerating strip 10 represents thirty minutes. Two numerating strips 10 have total sixty time marks to correspond to the sixty minutes on a face of the instructive clock. Each main body 101 is provided at a first end with a male connector, such as a butt 102, and at a second end with a female connector, such as a cavity 103 adapted to fitly engage with the butt 102. A recess 104 is formed at a back side of the main body 101 for soft magnets 105 to attach thereto, so that the numerating strip 10 could be attached to any magnetically attractive surface to facilitate teaching with the numerating strip 10. Two numerating strips 10 could be sequentially assembled by way of engaging the butt 102 on a preceding numerating strip 10 with the cavity 103 on a following numerating strip 10 to finally form a ring of numerating strip, as shown in FIG. 11.

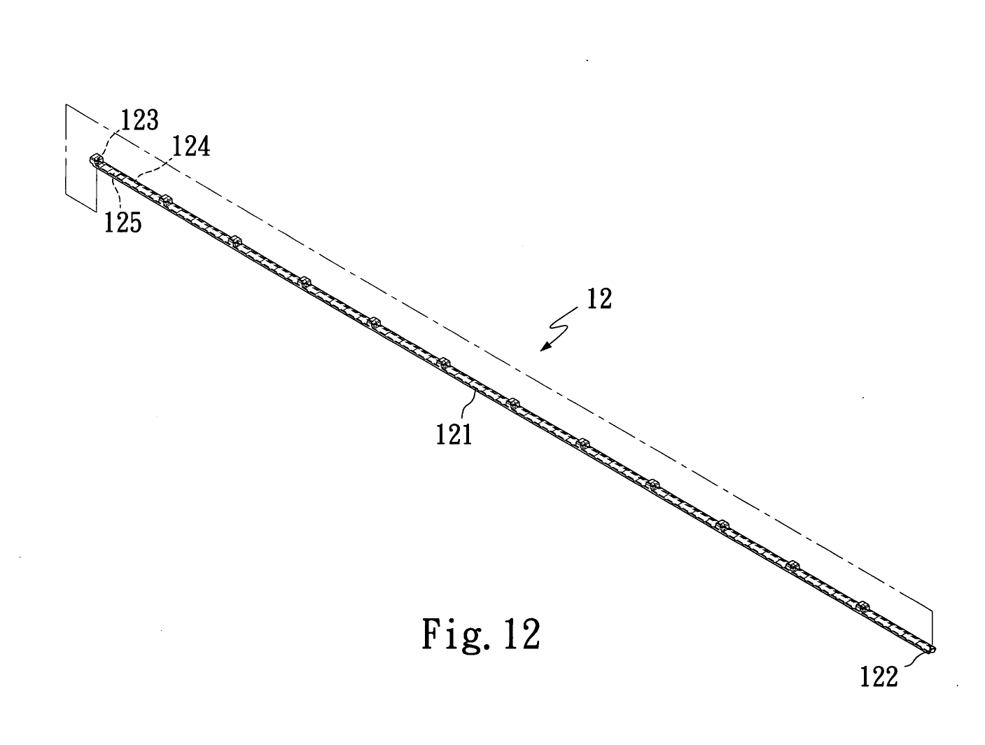

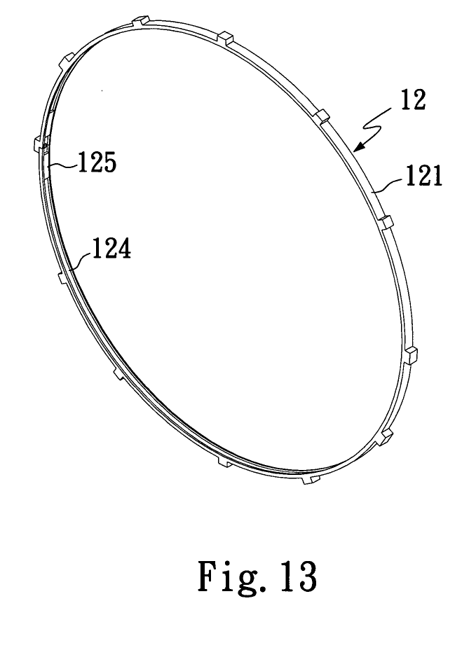

FIGS. 12 and 13 respectively shows a numerating strip 12 according to a sixth embodiment of the present invention before and after being formed into a ring. The numerating strip 12 includes a main body 121 having sixty equally spaced time marks provided on a front side thereof, and each of the time marks represents one minute, so that the numerating strip 12 represents sixty minutes. The numerating strip 12 has total sixty time marks to correspond to the sixty minutes on a face of the instructive clock. The main body 121 is provided at a first end with a male connector, such as a butt 122, and at a second end with a female connector, such as a cavity 123 adapted to fitly engage with the butt 122. A recess 124 is formed at a back side of the main body 121 for soft magnets 125 to attach thereto, so that the numerating strip 12 could be attached to any magnetically attractive surface to facilitate teaching with the numerating strip 12. The numerating strip 12 could be formed into a ring by way of engaging the butt 122 with the cavity 123, as shown in FIG. 13.

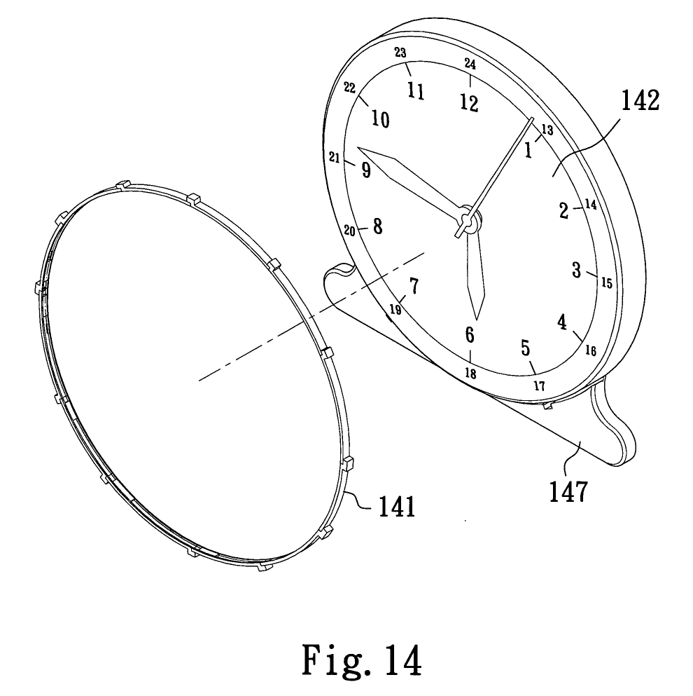

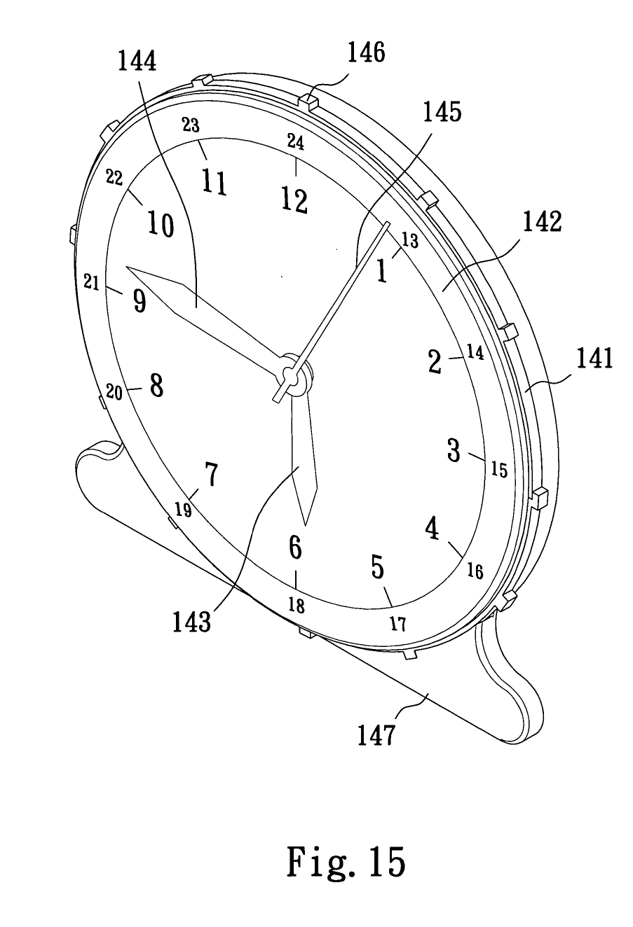

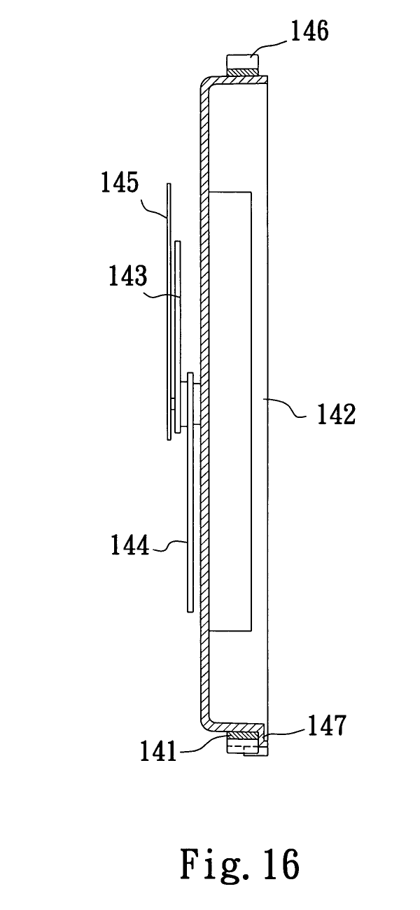

FIGS. 14, 15, and 16 shows a ring 141 formed from the numerating strip of any of the previously mentioned embodiments of the present invention is fitted around an outer circumferential surface of an instructive clock 142. Marking projections 146 provided on the ring 141 assist children in numerating the time marks on the ring 141 faster. The marking projections 146 are set in a plurality of cavities equally spaced on a support 147 of the instructive clock 142. Hour, minute, and second hands 143, 144, 145 are provided on the instructive clock 142 to show time for children to learn about time. The marking projections on the ring of numerating strip function to help children understand different segments of time. In the present invention, the marking projections are spaced at intervals of five minutes. Therefore, children know each one marking projection represents five minutes, and two marking projections represent ten minutes because five plus five equals ten. With this type of grouped design, children could quickly and correctly count even a quite large number of minutes.

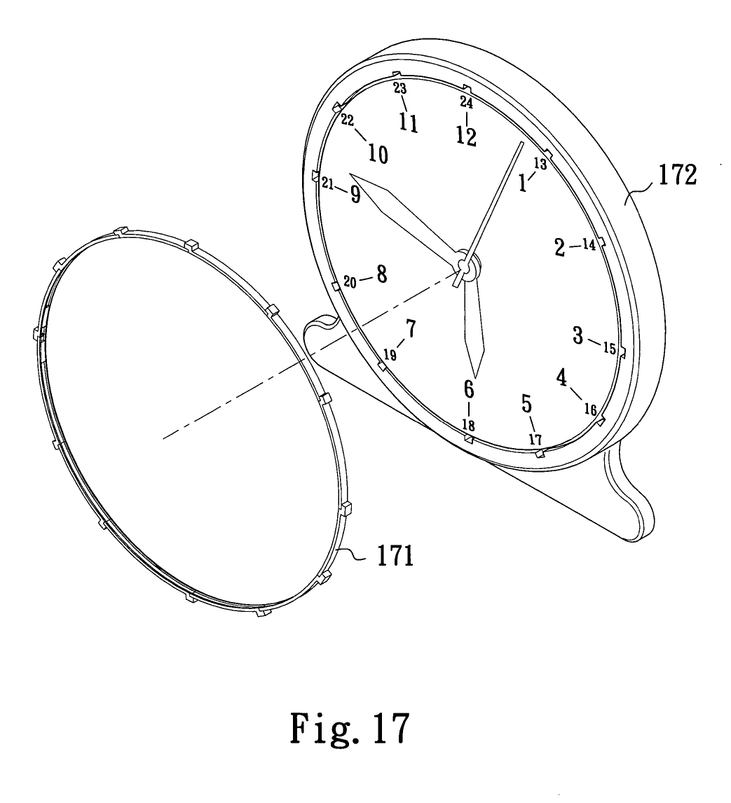

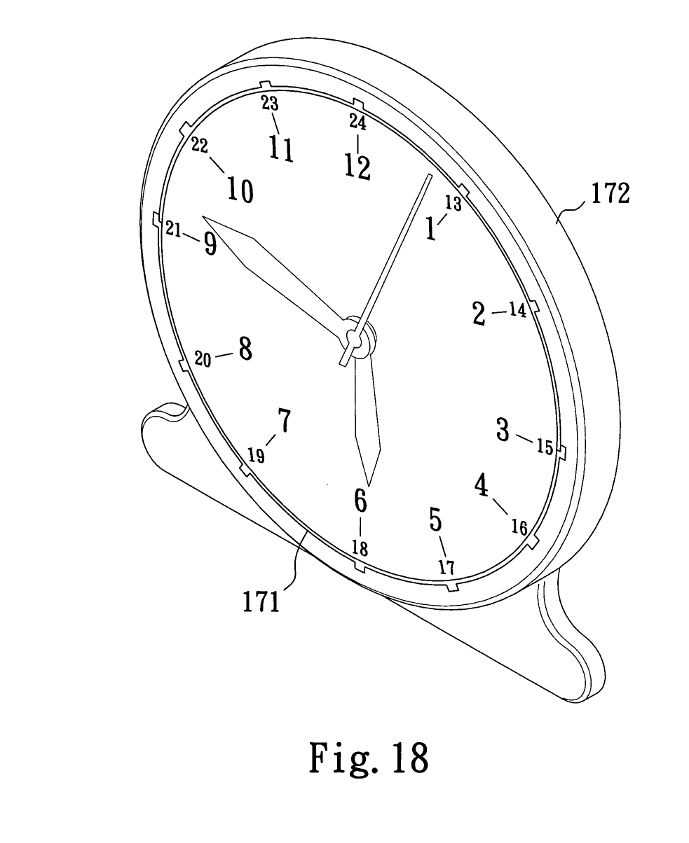

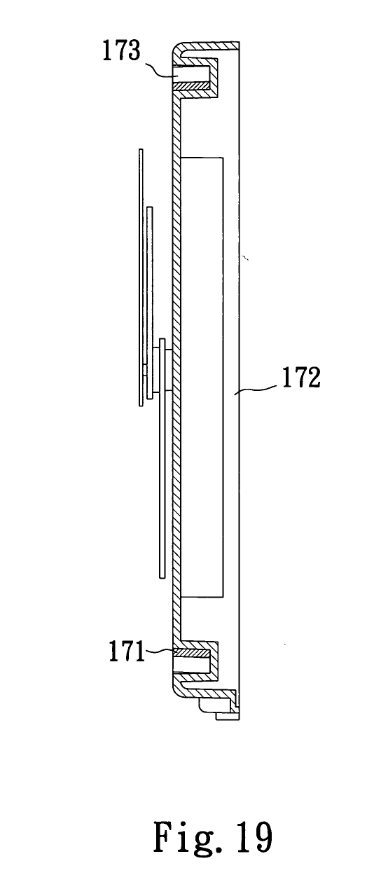

FIGS. 17, 18, and 19 shows a ring 171 formed from the numerating strip of any of the previously mentioned embodiments of the present invention is fitted in an annular groove provided on a face of an instructive clock 172. Marking projections 173 provided on the ring 171 are also set in the face of the instructive clock 172. In this fitting manner, the ring of numerating strip could always be set in the face of the instructive clock 172 no matter what an appearance the clock has. In this case, the instructive clock may be designed to have a configuration showing a certain cartoon or animal figure. A numerating strip that could be removed from a face of a clock would surprise children and arouse their interesting in learning time.

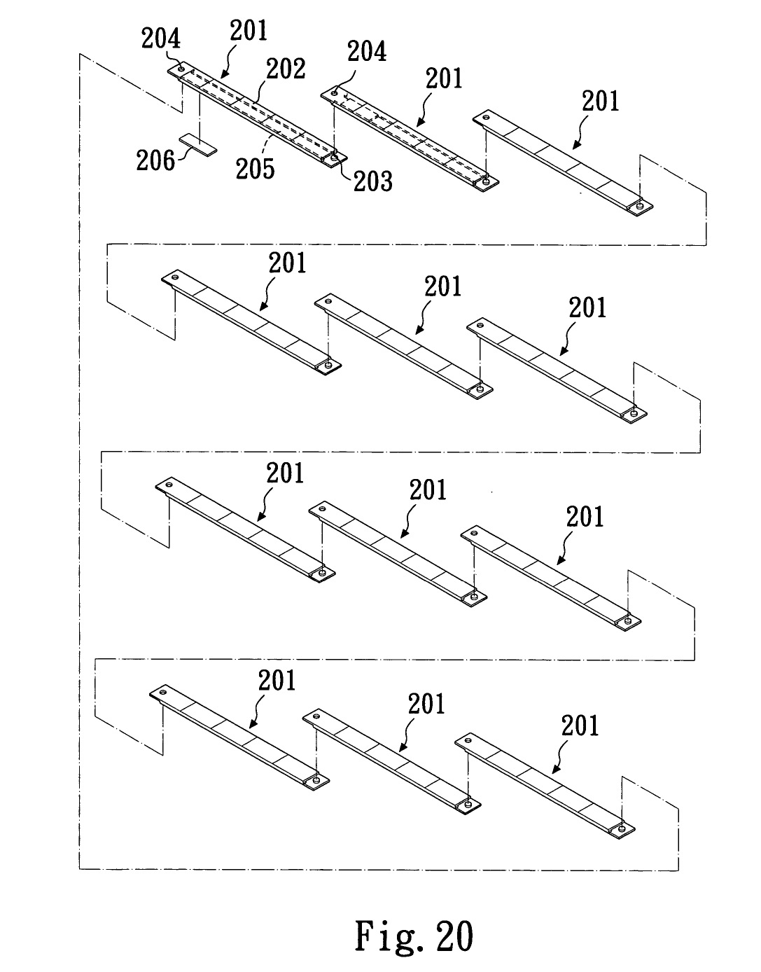

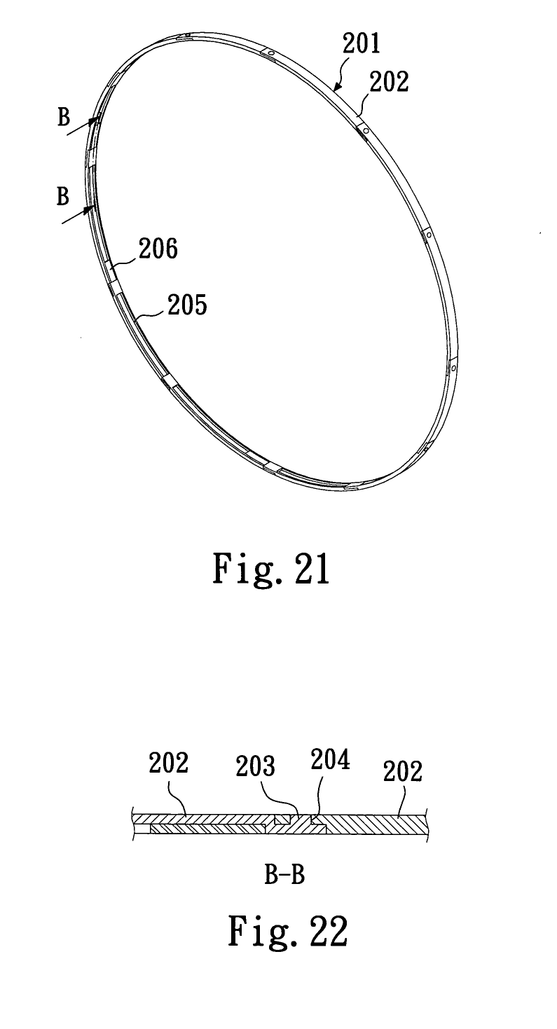

Please refer to FIGS. 20 and 21 that respectively shows a plurality of numerating strips 201 according to a seventh embodiment of the present invention before and after being assembled into a ring, and to FIG. 22 that is a fragmentary sectional views taken along line B-B of FIG. 21. As shown, the numerating strip 201 includes a main body 202 having a first end provided with a male connector, such as a butt 203, and a second end provided with a female connector, such as a through hole 204 adapted to fitly engage with the butt 203. A recess 205 is formed at a back side of the main body 202 for soft magnets 206 to attach thereto, so that the numerating strip 201 could be attached to any magnetically attractive surface to facilitate teaching with the numerating strip 201. The main body 202 of the numerating strip 201 is provided at a front side with five equally spaced time marks, and each of the time marks represents one minute, so as to facilitate teaching children about the numerals on the face of the instructive clock. Twelve numerating strips 201 could be assembled into a ring by way of engaging the butt 203 on a preceding numerating strip 201 with the through hole 204 on a following numerating strip 201. A thickness at the joint of the butt 203 and the through hole 204 is the same as an overall thickness of the main body 202, as shown in FIG. 22. The ring assembled from twelve numerating strips 201 (see FIG. 21) could be fitted around an instructive clock. The above-described structure for the flat joint of the butt 203 and the through hole 204 having the same overall thickness as that of the main bodies 202 of the numerating strip 201 is also applicable to one numerating strip that represents sixty minutes, two numerating strips representing thirty minutes each, three numerating strips representing twenty minutes each, four numerating strips representing fifteen minutes each, or six numerating strips representing ten minutes each.

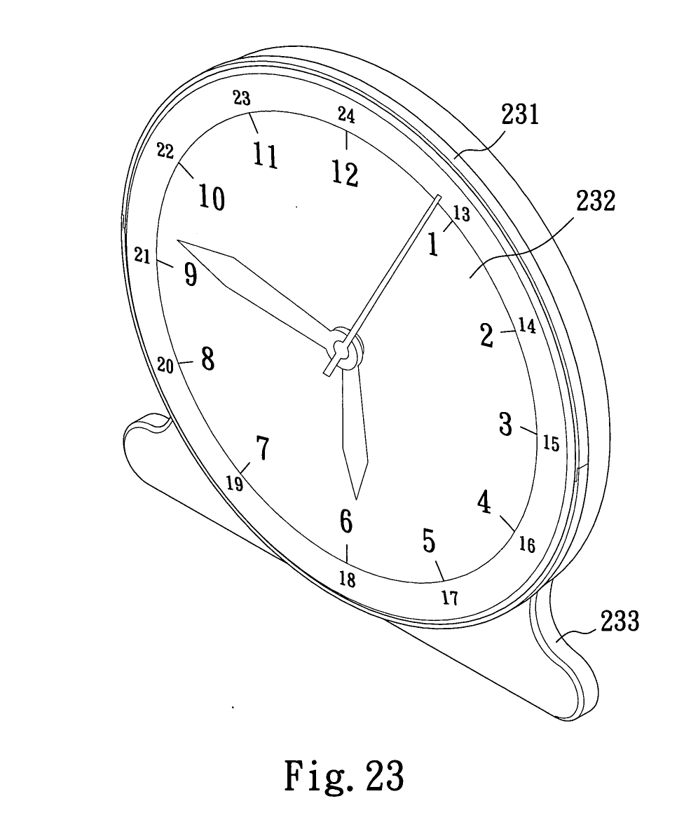

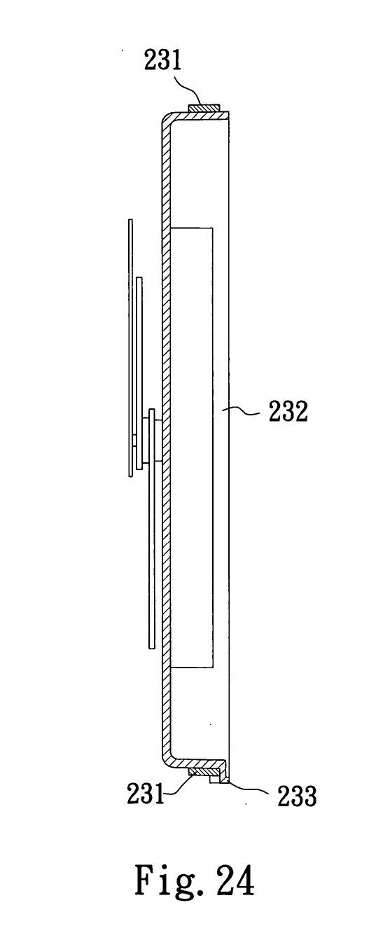

FIGS. 23 and 24 are assembled perspective view and sectioned side view, respectively, showing a ring 231 formed from the numerating strip of the seventh embodiment of the present invention is fitted around an outer circumferential surface of an instructive clock 232. The ring 231 is set between the clock 232 and a support 233 thereof. Since the joint of two adjacent numerating strips on the ring 231 have an overall thickness the same as that at other areas of the numerating strip, the ring of numerating strip 231 fitted around the instructive clock 232 is flush with the outer circumferential surface of the clock.

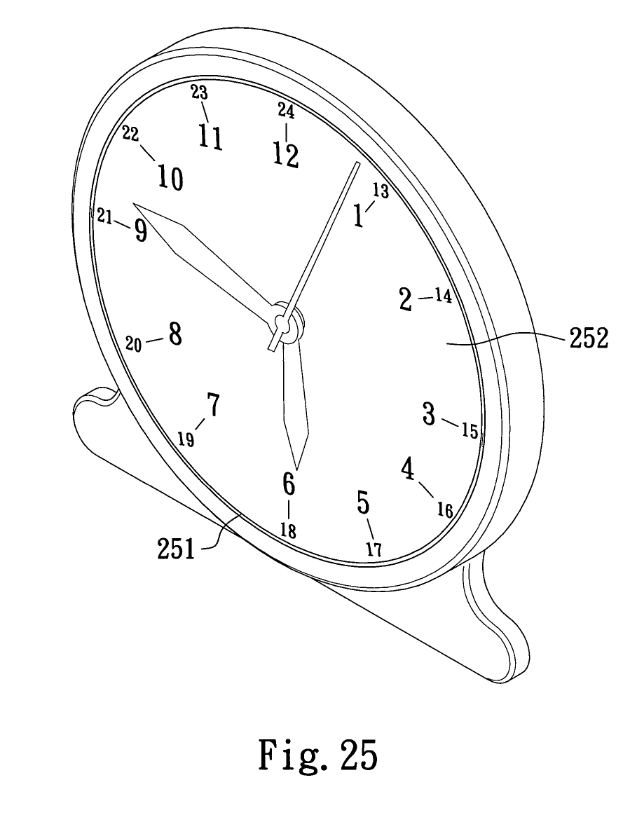

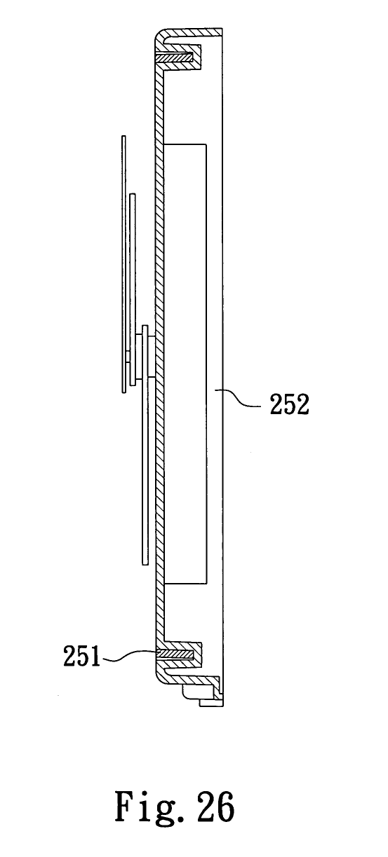

FIGS. 25 and 26 are assembled perspective view and sectioned side view, respectively, showing a ring 251 formed from the numerating strip of the seventh embodiment of the present invention is fitted in an annular groove provided on a face of an instructive clock 252. Since the ring of numerating strip 251 is a flat strip, the annular groove may have a width the same as the overall thickness of the ring of numerating strip 251. In this fitting manner, the ring of numerating strip could always be set in the face of the instructive clock, and the instructive clock may be designed to have any configuration showing a certain cartoon or animal figure. A numerating strip that could be removed from a face of a clock would also surprise children and arouse their interesting in learning time.

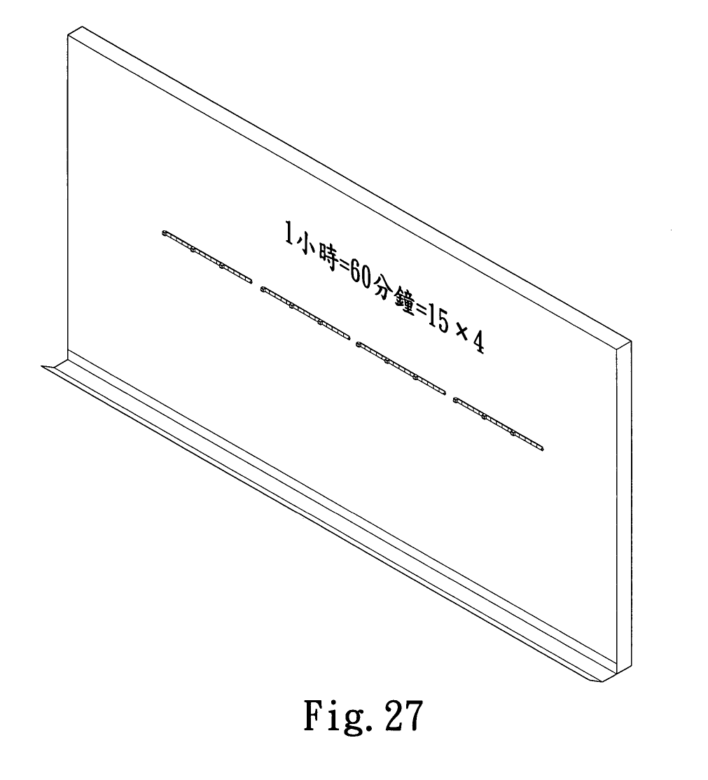

FIG. 27 shows an example of teaching children about the concept of time using the numerating strip of the present invention. To teach a child about the concept of one hour, it is advisable to first explain to the child that one hour equals to sixty minutes, and each time mark on the four numerating strips attached to a black board represents one minute. Each of the numerating strips on the black board has fifteen time marks and therefore represents 15 minutes. And, the four numerating strips represent four times of fifteen minutes or sixty minutes or one hour. The child may also numerate the time marks on the numerating strips to know a time difference, for example, between twenty minutes past one o'clock (1:20) and ten minutes to two o'clock (1:50). To do this, simply remove from the instructive clock the numerating strips located between the fourth and the eleventh hour numerals, and allow the child to count the time marks on the removed numerating strips, or to add up all the five-minute grouped marking projections. And the child could find out the answer very quickly. Alternatively, it is also possible to teach the child to numerate forty time marks on the numerating strips located after the time point of 2:20 and then tell the time. To do this, simply ask the child to put numerating strips showing total forty time marks behind the time point of 2:20. The numerating strips of the present invention may also be used to learn the addition of two or more different time segments. For example, to calculate a total length of three hours and thirty minutes and two hours and twenty minutes, first add up the numbers of hours, and then put one or more numerating strips showing total twenty time marks on the instructive clock behind the sixth hour numeral. The numerating strips of the present invention may also be used to learn the subtraction of one time segment from another time segment. For example, to subtract two hours and ten minutes from six hours and forty minutes, first subtract two from six, and then put one or more numerating strips representing total ten minutes on the instructive clock behind the sixth hour numeral. And, the child could learn that forty minutes could be divided into ten and thirty minutes. Through different permutations and combinations of the numerating strips of the present invention, children could easily learn about addition and subtraction and the concept of time, and become more sensitive to numbers.

The time marks on the numerating strips of the present invention corresponding to the hour or minute numerals on the instructive clock are not necessarily scales, but may be numerals, combinations of scales and numerals, dots, dents, or patterns. And, the time marks on the numerating strip of the present invention are not necessarily minute marks that appear every one minute, but may be hour marks that appear every one hour, five-minute marks that appear every five minutes, or other specific time interval marks, such as, for example, 15-minute marks, 30-minute marks, etc.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An instructive clock with removable numerating strips, comprising:
a clock having time scales provided on a face thereof to show a time point indicated by hour, minute, and second hands of said clock; and
at least one numerating strip in the form of an elongated strip for annularly fitting on said clock, said at least one numerating strip being provided on a front side with time marks corresponding to said time scales provided on the face of said clock, and at two ends with corresponding female and male connectors that could be fitly engaged with each other.

2. The instructive clock with removable numerating strips as claimed in claim 1, wherein said clock is provided on the face with an annular groove corresponding to said time scales on the face, and said at least one numerating strip is fitted in said annular groove.

3. The instructive clock with removable numerating strips as claimed in claim 1, wherein said clock includes a support located below said clock, and an annular groove provided on a circumferential surface of said clock between said clock and said support for said at least one numerating strip to fit therein.

4. The instructive clock with removable numerating strips as claimed in claim 1, wherein said time marks provided on said at least one numerating strip corresponding to said time scales on said clock are in a form selected from the group consisting of scales, numerals, combinations of scales and numerals, dots, dents, and patterns; and wherein said time marks provided on said at least one numerating strip are selected from the group consisting of hour marks, minute marks, and other different time interval marks.

5. The instructive clock with removable numerating strips as claimed in claim 4, wherein said time marks are selected from the group consisting of hour marks that appear every 60 minutes, half-hour marks that appear every 30 minutes, 20-minute marks that appear every 20 minutes, 15-minute marks that appear every fifteen minutes, 10-minute marks that appear every ten minutes, and 5-minute marks that appear every five minutes.

6. The instructive clock with removable numerating strips as claimed in claim 5, wherein said at least one numerating strip is fitted on said clock in a manner selected from the group consisting of fitting one single strip representing one hour, two serially connected strips representing thirty minutes each, three serially connected strips representing twenty minutes each, four serially connected strips representing fifteen minutes each, six serially connected strips representing ten minutes each, and twelve serially connected strips representing five minutes each.

7. The instructive clock with removable numerating strips as claimed in claim 1, wherein said at least one numerating strip is provided at a back side with a recess for soft magnets to attach thereto.

8. The instructive clock with removable numerating strips as claimed in claim 1, wherein said connectors provided at two ends of said at least one numerating strip are a female connector in the form of a cavity and a male connector in the form of a butt.

9. The instructive clock with removable numerating strips as claimed in claim 1, wherein said connectors provided at two ends of said at least one numerating strip are a female connector in the form of a through hole and a male connector in the form of a butt.
